(19) United States
(12) Patent Application Publication
(10) Pub. No.: US 2012/0272288 A1
(43) Pub. Date: Oct. 25, 2012

(54) METHODS AND APPARATUSES FOR DETERMINING STRENGTH OF A RHYTHM-BASED PASSWORD

(75) Inventors: Daniel Lee Ashbrook, Santa Monica, CA (US); Felix Xiaozhu Lin, Houston, TX (US); Sean Michael Whtie, Los Angeles, CA (US)

(73) Assignee: Nokia Corporation

(21) Appl. No.: 13/092,383

(22) Filed: Apr. 22, 2011

(51) Int. Cl. G06F 21/00

(52) U.S. Cl. 726/1

(57) ABSTRACT

Methods, apparatus, and computer program products are provided for determining the strength of a rhythm-based password to facilitate selection by a user of an appropriately secure rhythm-based password. A method may include receiving input defining a rhythm-based password and determining, by a processor, at least one property of the rhythm-based password. The method may also determine a strength value of the rhythm-based password based at least in part on the at least one property of the rhythm-based password. Corresponding apparatus and computer program products may also be provided.

### TECHNOLOGICAL FIELD

Example embodiments of the present invention relate generally to preventing unauthorized access through use of rhythm-based passwords and, more particularly, relate to methods and apparatuses for determining the strength of rhythm-based passwords.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

Often mobile computing devices incorporate information and applications personal or private to a user. As such, there is an increased need for protection from unauthorized access to these mobile computing devices. As such, passwords are often utilized in order to permit a user to be authenticated prior to permitting access to a mobile computing device. When a user chooses a password, it may be helpful for the user to have feedback as to the strength of the password. In this regard, the strength of a password identifies how easily that password may be guessed with a stronger password generally being more desirable than a weaker password.

For textual passwords, there are various techniques for determining their strength. For example, the strength of text-based passwords may be based upon the numbers of characters, uppercase letters, lowercase letters, numbers, symbols and middle numbers or symbols. Indeed, the strength of text-based passwords may be enhanced as the numbers of characters, uppercase letters, lowercase letters, numbers, symbols and middle numbers or symbols are increased. The strength of text-based passwords may also be based upon and, more particularly, reduced as a result of a determination that the password includes letters only, numbers only, repeat characters regardless of the case, consecutive uppercase letters, consecutive lowercase letters, consecutive numbers, sequential letters, sequential numbers or sequential symbols. As such, the strength of a text-based password may be based upon the scores assigned to one or more of the foregoing properties with the password having an overall numeric total score.

### BRIEF SUMMARY

An example embodiment of the present invention provides methods, apparatus and computer program products for determining the strength of a rhythm-based password. Based upon the strength of the rhythm-based password, feedback may be provided to a user as to the relative strength or weakness of the rhythm-based password. The feedback that is based upon the strength of the rhythm-based password may permit a user to select a rhythm-based password that provides the desired degree of security.

Some embodiments provide a method, apparatus, and computer program product for determining properties of a rhythm-based password and determining a strength value of the rhythm-based password based on the properties of the rhythm based password. Moreover, in some embodiments, a strength value may be provided to the user to aid in selecting an appropriately secure rhythm-based password. As such, a user can receive information that will aid in choosing a strong rhythm-based password that will help protect unauthorized access to the user's device.

In one example embodiment, a method may include receiving input defining a rhythm-based password and determining, by a processor, at least one property of the rhythm-based password. The method of this embodiment also determines a strength value of the rhythm-based password based at least in part on the at least one property of the rhythm-based password.

In another example embodiment, an apparatus comprising at least one processor and at least one memory storing computer program code, wherein the at least one memory and stored computer program code are configured, with the at least one processor, to cause the apparatus to at least receive input defining a rhythm-based password. The at least one memory and stored computer program code are configured, with the at least one processor, to further cause the apparatus of this example embodiment to determine at least one property of the rhythm-based password. The at least one memory and stored computer program code are configured, with the at least one processor, to further cause the apparatus of this example embodiment to determine a strength value of the rhythm-based password based at least in part on the at least one property of the rhythm-based password.

In a further example embodiment, a computer program product is provided. The computer program product of this example embodiment includes at least one non-transitory computer-readable storage medium having computer-readable program instructions stored therein. The program instructions of this example embodiment comprise program instructions configured to cause an apparatus to perform a method comprising receiving input defining a rhythm-based password. The computer program product of this example embodiment further comprises determining at least one property of the rhythm-based password. The computer program product of this example embodiment additionally comprises determining a strength value of the rhythm-based password based at least in part on the at least one property of the rhythm-based password.

In yet another example embodiment, an apparatus that includes means for receiving input defining a rhythm-based password. The apparatus may also comprise means for determining at least one property of the rhythm-based password. The apparatus may further comprise means for determining a strength value of the rhythm-based password based at least in part on the at least one property of the rhythm-based password.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a block diagram of an apparatus that includes a user interface according to an example embodiment;

FIG. 2 is a schematic block diagram of a mobile terminal according to an example embodiment;

FIG. 3 illustrates a flowchart according to an example method for determining strength of a rhythm-based password according to an example embodiment;

FIG. 4 illustrates a flowchart according to one embodiment of the method of FIG. 3 for determining strength of a rhythm-based password;

FIG. 5 illustrates a flowchart according to another embodiment of the method of FIG. 3 for determining strength of a rhythm-based password;

FIG. 6 illustrates a flowchart according to a further embodiment of the method of FIG. 3 for determining strength of a rhythm-based password; and

FIG. 7 illustrates a flowchart according to another example method for determining strength of a rhythm-based password based upon a comparison to one or more predefined rhythm-based passwords according to an example embodiment.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

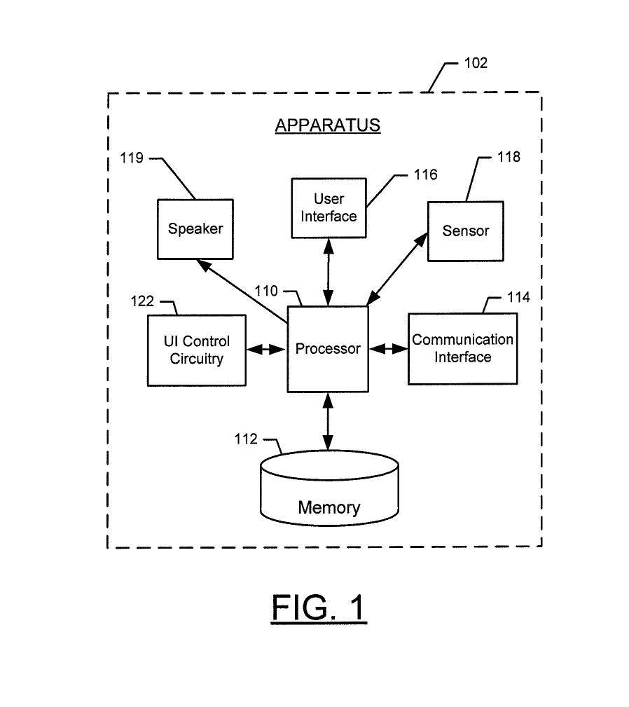

FIG. 1 illustrates a block diagram of an apparatus 102 for determining the strength of a rhythm-based password according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for determining the strength of a rhythm-based password, other configurations may also be used to implement embodiments of the present invention.

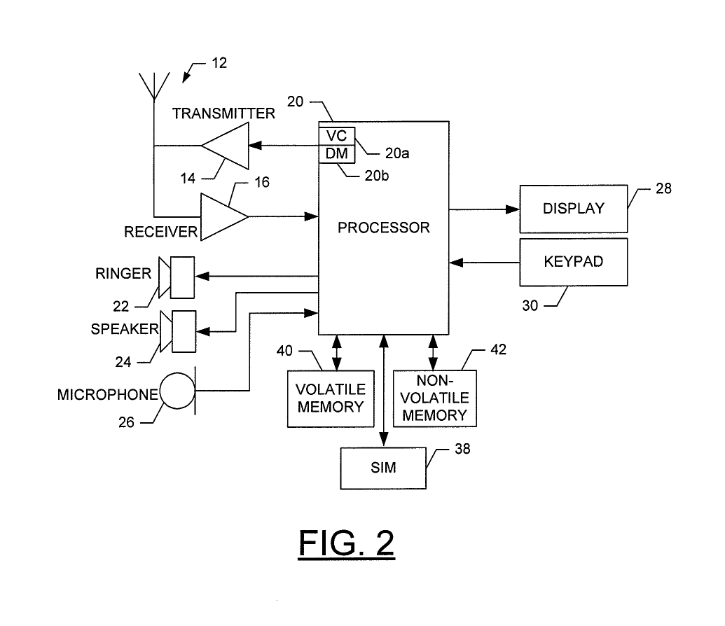

The apparatus 102 may be embodied as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the electronic device are illustrated and will be hereinafter described for purposes of example, other types of electronic devices, such as mobile telephones, mobile computers, personal digital assistants (PDAs), pagers, laptop computers, desktop computers, gaming devices, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The user input interface may comprise devices allowing the mobile terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile terminal.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, sensor 118, speaker 119, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, user interface 116, sensor 118, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. The communication interface 114 may additionally be in communication with the memory 112, user interface 116, speaker 119, and/or UI control circuitry 122, such as via a bus.

In some embodiments, the apparatus 102 may include a speaker 119 that is in communication with the processor 110. The speaker 119 may be configured to emit a sound in response to receiving an instruction from the processor 110. For example, a user may input an instruction into the apparatus 102 that may cause the processor 110 to instruct the speaker 119 to emit a sound corresponding to the user input. In a non-limiting example, a user may input a string of impulses, e.g., taps, that define a rhythm. The processor 110 can recognize the user input and instruct the speaker 119 to play back the rhythm to the user.

In some embodiments, the apparatus 102 may include a user input interface, such as a sensor 118 that is in communication with the processor 110. The sensor 118 may be configured to determine certain properties of user input, such as the time at which the user input was received, the attack velocity of the user input, the decay associated with the user input, the sustain time of the user input, and the release velocity of the user input. For example, in some embodiments, the sensor 118 may be an accelerometer, pressure sensor, pressure sensitive screen, or similar device.

The user interface 116 may be in communication with the processor 110 and configured to receive an indication of a user input and/or to provide an audible, visual, mechanical, or other output to a user. As such, the user interface 116 may include, for example, a keyboard, a mouse, a joystick, a display, a touch screen display, a microphone, a speaker, and/or other input/output mechanisms. In embodiments wherein the apparatus 102 is embodied as a mobile terminal 10, the user interface 116 may be embodied as or comprise the user input interface, such as the display 28 and keypad 30 (shown in FIG. 2). The user interface 116 may be in communication with the memory 112, communication interface 114, sensor 118, speaker 119, and/or UI control circuitry 122, such as via a bus. In some example embodiments, the user interface may comprise a single input/output mechanism. In other embodiments, the user interface may comprise a content display and touch display. In some embodiments, the user interface may comprise a touch display user interface with a content display portion and a dedicated user input portion, such as a virtual keyboard, virtual piano, or an application with a designated key for user input.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive a user input from a user interface 116, such as a touch display. The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine an element/instruction/command that corresponds with a key, or image, displayed on the touch display user interface at the determined position or within a predefined proximity (e.g., within a predefined tolerance range) of the determined position. The processor 110 may be further configured to perform a function or action related to the key corresponding to the element/instruction/command determined by the UI control circuitry 122 based on the position of the touch or other user input. A non-limiting example of this function or action includes displaying a string of notes corresponding to a rhythm on the content display screen of the user interface 116 of the apparatus 102, wherein the string of notes corresponds to a string of user inputs or impulses at the determined position in which the user-input originated. Example embodiments are useful in performing functions such as creating song rhythms or playing songs.

The touch display may not only detect physical contact, but may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a projected capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

It is often desirable to protect devices such as apparatus 102 by preventing unauthorized access. Also, it may be desirable to link devices, such as apparatus 102, with other devices. As such, passwords may be used for authentication purposes to offer protection of the device by requiring verification of a proper user. One type of password is a text-based password. Text-based passwords, however, may be difficult to remember and are limited by the input options available to a user. In fact, some devices may be limited to a single input/output mechanism, thereby making text-based passwords impracticable. As such, rhythm-based passwords have been developed to offer password protection without some of the limitations associated with text-based passwords. For example, rhythm-based passwords, such as a line from the user's favorite song, may be more personalized and easier to remember than a text-based password.

While rhythm-based passwords may be a desirable alternative to text-based passwords in at least some circumstances, some rhythm-based passwords may be easy to overhear and/or commonplace, such that these rhythm-based passwords are relatively easy to recognize or guess. Like text-based passwords, however, rhythm-based passwords should generally be strong and difficult to guess so that the mobile computing device remains secure. In contrast to a deterministic series of letters, numbers, and symbols that define a text-based password, rhythm-based passwords consist of impulses separated by time. The impulses can be binary or real-valued with the time between impulses being determined according to various granularities. Because a user inputs the impulses that comprise the rhythm-based password via a sensor, such as a touch screen display, a rhythm-based password will generally not be identical every time. As a result of these variations, the recognition of a rhythm-based password and the determination of the strength of a rhythm-based password are distinct from the techniques employed in conjunction with text-based passwords. Accordingly, embodiments of the present invention are generally directed to the determination of the strength of rhythm-based passwords which may be utilized for authentication.

In order to commence the authentication process, the processor 110 may be configured to prompt a user to input a rhythm-based password in certain predefined circumstances, such as by presenting an appropriate message upon the user interface 116. For example, upon initiation of the apparatus 102, e.g., turning the apparatus on, the processor 110 may prompt a user to enter a rhythm-based password. In some embodiments, the processor 110 may also be configured to prompt a user for a rhythm-based password upon initiation of an application/program or after a query from an application or another device. The rhythm-based password may be entered in various manners. In some embodiments, the processor 110 may instruct the user interface 116 to display a key/button that may be actuated, e.g., tapped, by a user to enter the rhythm-based password. In other embodiments, the user interface 116 may comprise a user input configured for direct entry of a rhythm-based password, such as entry of a series of taps. Also, in some embodiments, the user may themselves initiate entry of a rhythm-based password for authentication purposes without any prompt being provided by the processor 110. In this embodiment, the apparatus 102 may simply be listening for the rhythm-based password to be input by the user. While generally described herein as being input by a user, the rhythm-based password need not be input by a user, but may be otherwise provided, such as by a machine, from memory in the instance of a prestored rhythm-based password or the like.

The apparatus 102 may be configured to receive, e.g., through the user interface 116, user input in the form of a rhythm-based password. In some embodiments, the apparatus 102 may be configured to receive user input in the form of a series of impulses, taps, or other binary mechanism through a user interface 116, such as a button or touch display. The processor 110 may be configured to define the rhythm-based password that has been entered by the user and to store the rhythm-based password in the memory 112. In some embodiments, the processor 110 may prompt a user to enter a rhythm-based password that will act as the security password. The processor 110 may be configured to store the received rhythm-based password in the memory 112 as the secure rhythm-based password. Additionally or alternatively, the processor 110 may be configured to associate the received rhythm-based password with a designated user such that multiple users may access at least a portion of the functionality of apparatus 102 with a user-specific rhythm-based password. The rhythm-based password may be defined in various manners. In some embodiments, however, the processor 110 may define a rhythm-based password by the interval between each pair of consecutive impulse. As a non-limiting example, the processor 110 may receive user input in a series of taps similar to the famous “Shave and a Haircut, Two Bits” rhythm. The processor 110 may define that rhythm-based password as “56, 56, 37, 61, 73, 60.” In this example, the processor 110 is configured to define the rhythm-based password by the number of milliseconds between each tap from the user such that there are 56 milliseconds between the first and second taps, 56 milliseconds between the second and third taps, 37 milliseconds between the third and fourth taps and so on.

The processor 110 may be configured to direct the speaker 119 to playback the received rhythm-based password to provide a self-verification to the user. Alternatively or additionally, the processor 110 may be configured to provide feedback to the user regarding receipt of the rhythm-based password in other manners, such as by the presentation of a predefined message or flashing of the display 28, vibrational feedback, etc. In some embodiments, the processor 110 may be configured to playback a rhythm-based password as the user is inputting the rhythm-based password to provide relatively real-time feedback.

The processor 110 may be configured to limit access to at least a portion of the functionality of apparatus 102 before a rhythm-based password is received. Alternatively, the processor 110 may be configured to limit access to another device before a rhythm-based password is received. For example, the apparatus 102 may be a key fob that must receive a rhythm-based password prior to authorizing access to a vehicle. Thus, before allowing access to at least a portion of the functionality of the apparatus 102, the processor 110 may require a user to input a rhythm-based password that matches the secure rhythm-based password that has previously been stored by the apparatus. The processor 110, therefore, may be configured to verify that a received rhythm-based password matches, or is sufficiently similar to, the secure rhythm-based password in order to authenticate a user. Rhythm-based passwords, however, can be difficult to properly verify as the user entering the rhythm-based password may not enter the rhythm-based password exactly the same each time. Therefore, an acceptable margin of error may be considered by the processor during verification of the received rhythm-based password.

Embodiments of the present invention provide methods, apparatus and computer program products for determining the strength of a rhythm-based password. Based upon the strength that is determined for the rhythm-based password, feedback may be provided to a user as to the relative strength or weakness of the rhythm-based password such that a user can select a rhythm-based password that has a strength consistent with the level of security desired by the user.

In this regard, the processor 110 may be configured to determine at least one property of a rhythm-based password that is received by the sensor 118, such as a result of user input. For example, as described herein, rhythm-based passwords may be comprised of a series of impulses that are spaced apart from one another by respective intervals. In one embodiment, the sensor 118 may detect the time at which each impulse of a rhythm-based password is received such that the rhythm-based password is defined by the length of each respective interval, thereby resulting in the rhythm-based password being defined as a series of numbers representative of the time of the respective intervals. Alternatively, the sensor 118, such as a pressure sensor, may measure a number of other properties associated with each impulse in addition to the time at which each impulse is received. For example, the sensor 118 may measure the attack velocity of the user input, e.g., the force with which a press is made, the decay associated with the user input, e.g., the time required for the force of the press to drop to a steady level, the sustain time of the user input, e.g., the length of time that the steady level is maintained, and/or the release velocity of the user input, e.g., a measure of how quickly the press is released. As such, the rhythm-based password may be defined by one or more of these additional properties that are measured by the sensor 118. In either instance, the processor 110 may store the properties of the rhythm-based password in the memory 112.

Based upon the properties of the rhythm-based password that are measured by the sensor 118, the processor 110 may determine one or more additional properties of the rhythm-based password, such as based upon calculations that take into account the properties measured by the sensor. As described below, these additional properties of the rhythm-based password may include one or more properties that are determined from a consideration of the rhythm-based password on an overall basis and/or one or more rhythmic properties that are based upon intervals between the impulses of the rhythm-based password. The one or more additional properties of the rhythm-based password that are determined by the processor 110 may also be stored in the memory 112.

The processor 110 may also be configured to determine a strength value corresponding to the strength of the rhythm-based password. In some embodiments, the processor 110 may be configured to determine the strength value of a rhythm-based password based at least in part on at least one property of the rhythm-based password. For example, the processor 110 may be configured to determine a strength value based on multiple properties of the rhythm-based password with a score being assigned to each property based upon its indication of or contribution to the strength of the rhythm-based password and an overall score being determined for the rhythm-based password based upon a combination of the individual scores. The overall score may, in turn, define the strength value of the rhythm-based password. Furthermore, the processor 110 may be configured to assign greater weight to certain properties of the rhythm-based password such that the individual scores of these properties contribute more, at least on a proportional basis, than other properties that have a lesser weight to the overall score. By way of example, the processor 110 may base the strength value upon the number of impulses that comprise the rhythm-based password and the overall time that is required for the user to input the rhythm-based password with the number of impulses being more greatly weighted than the overall time such that the number of impulses contributes more greatly to the determination of the strength value than the overall time. For example, the processor 110 may determine that the rhythm-based password has a score of 6 (out of 10) for the number of impulses and a 3 (out of 10) for the overall time. The processor 110 may also determine that the number of impulses is twice as important as the overall time in the determination of the strength value. Therefore, the processor 110 of this example may determine the strength value for the received rhythm-based password to be a 5 (out of 10) (e.g., (6+6+3)/3).

Additionally, the processor 110 may be configured to provide an indication to the user, such as via the user interface 116 or speaker 119, of the strength of the rhythm-based password. In some embodiments, the indication could be the strength value and/or a percentage corresponding to the relationship of the strength value to a maximum strength value. Based upon the strength of the rhythm-based password, a user may determine if the rhythm-based password provides a sufficient level of protection. In one embodiment, the processor 110 may also be configured to determine whether the strength of the rhythm-based password is acceptable by comparing the strength value to a predefined strength value. In this instance, the processor 110 may also provide an indication to the user, such as via the user interface 116, speaker 119 or otherwise, of the acceptance, or not, of the rhythm-based password. In addition to providing the strength value of the rhythm-based password and, in one embodiment, an indication as to whether the rhythm-based password is acceptable, the processor 110 of another embodiment may be configured to also provide an indication regarding individual properties of the rhythm-based password, such as an indication as to which, if any, properties of the rhythm-based password failed to have a score that satisfied a minimum predetermined score for the respective property. Thus, a user could determine which of the properties of the rhythm-based password might be modified in order to increase its strength.

In one embodiment, the processor 110 may be configured to determine one or more properties of a rhythm-based password based upon a consideration of the rhythm-based password on an overall basis including the determination of one or more overall password properties of the rhythm-based password. The processor 110 may determine various different overall password properties including, for example, the length of the rhythm-based password, variations within the rhythm-based password and the time required for entry of the rhythm-based password.

The length of the rhythm-based password may be determined by the number of impulses that comprise the rhythm-based password. In one embodiment, longer rhythm-based passwords may be awarded a greater score and may therefore be considered stronger than shorter rhythm-based passwords. The variation of the rhythm-based password may be determined based upon the difference in the intervals between impulses and/or differences between other properties of the rhythm-based password that are measured by the sensor 118, such as the attack velocity of the user input, the decay associated with the user input, the sustain time of the user input and/or the release velocity of the user input. The variation of the rhythm-based password may be defined in various manners including the standard deviation between the properties of the rhythm-based password as measured by the sensor 118. For example, the processor 110 may determine the mean duration of the intervals and, in turn, the standard deviation of the rhythm-based password based upon the average difference between each interval and the mean duration of the intervals. In one embodiment, rhythm-based passwords having more variation, such as a greater standard deviation, may be awarded a greater score and may therefore be considered stronger than rhythm-based passwords with less variation. In regards to the time required for entry of the rhythm-based password, rhythm-based passwords that require less time for entry may be determined be awarded a greater score an may therefore be considered stronger than rhythm-based passwords that require more time for entry. This inverse relationship between the time for entry of a rhythm-based password and the strength of the rhythm-based password may be based upon a rhythm-based password that is shorter being more difficult to overhear and, therefore, more secure.

In another embodiment, the processor 110 may be configured to determine at least one rhythmic property based upon intervals between the impulses that comprise the rhythm-based password. Examples of rhythmic properties may include a size of the intervals between impulses, e.g., length of time of the intervals, the similarity between consecutive intervals and the presence of one or more predefined impulse sequences. Since a mixture of long and short intervals may increase the strength of a rhythm-based password, the processor 110 may consider the size of the intervals by determining the number of long intervals, e.g., the number of intervals greater than a predefined value or greater than a predefined percentage of the overall length of the rhythm-based password, and the number of short intervals, e.g., the number of intervals less than a predefined value or less than a predefined percentage of the overall length of the rhythm-based password, with the strength of the rhythm-based password increasing with increased numbers of long and short intervals and decreasing with fewer numbers of long and short intervals. In one example in which the overall length of the rhythm-based password is 1000 milliseconds, long intervals may be defined to be those that are greater than 60% of the overall length, that is, greater than 600 milliseconds, and short intervals may be defined to be those that are less than 5% of the overall length, that is, less than 50 milliseconds. The interval size of each individual impulse may be determined by measuring the length of time between impulses.

The similarity between consecutive intervals of the rhythm-based password may be determined based upon the difference between each pair of consecutive intervals. As a rhythm-based password may be stronger if consecutive intervals are dissimilar, the processor 110 of one embodiment may award a greater score for a rhythm-based password having consecutive intervals that are more dissimilar than for a rhythm-based password having consecutive intervals that are more similar. By way of example, a rhythm-based password may have an overall length of 1000 milliseconds and may have two consecutive intervals of 100 milliseconds and 110 milliseconds. In this example, the score for the rhythm-based password based upon the similarity between consecutive intervals may be based upon the overall length of the rhythm-based password and the difference between the length of the consecutive intervals, such as −(1000/(110−100))=−100.

In regards to the presence of one or more predefined impulse sequences, the processor 110 may determine if the rhythm-based password includes one or more predefined impulse sequences. For example, the processor 110 may determine if the rhythm-based password includes one or more predefined impulse sequences that satisfy predetermined criteria. For example, the processor 110 may determine if the rhythm-based password includes a fast double tap by determining if the rhythm-based password includes an interval that is less than a predefined length, such as 50 milliseconds. Additionally or alternatively, the processor 110 may determine if the rhythm-based password includes a long interval, such as an interval greater than a predefined value, e.g., 250 milliseconds. The processor 110 may also or alternatively determine if the rhythm-based password includes one or more predefined impulse sequences by comparing impulse sequences of the rhythm-based password to one or more predefined impulse sequences stored, for example, in the memory 112. In this regard, the processor 110 may determine that the rhythm-based password includes a predefined impulse sequence by determining that an impulse sequence of the rhythm-based password matches or is sufficiently similar to, e.g., within a predetermined mathematical distance, e.g., a Euclidian distance or a distance determined by Dynamic Time Warping of, a predefined impulse sequence. The strength of a rhythm-based password may be dependent upon the inclusion of a predefined impulse sequence in various predetermined manners. In this regard, the strength of a rhythm-based password may be diminished by the inclusion of some predefined impulse sequences, such as the inclusion of repeated letters, e.g., sss, but increased by the inclusion of other predefined impulse sequences, e.g., a predefined mix of capital and lowercase letters or a predefined mix of long and short impulses.

The processor 110 may determine the strength value of a rhythm-based password based upon the scores of the various properties of the rhythm-based password as determined in the manner described above. For example, the processor 110 may combine the scores of the various properties of the rhythm-based password, such as by summing the scores. As noted above, the processor 110 may also weight the scores of the various properties based upon, for example, the relative contributions of the various properties to the strength of the rhythm-based password.

In addition to or instead of determining the strength value of a rhythm-based password in the manner described above, the processor 110 of one embodiment may determine the strength value by comparing one or more properties of the rhythm-based password to respective properties of one or more predefined rhythm-based passwords. In this regard, the memory 112 may be configured to store one or more predefined rhythm-based passwords, such that the memory serves as a database of predefined rhythm-based passwords. Additionally or alternatively, the memory 112 may be configured to store one or more properties for one or more predefined rhythm-based passwords. The memory 112 may also store respective strength values for the one or more predefined rhythm-based passwords.

In accordance with this embodiment, the processor 110 may be configured to determine the strength value of a rhythm-based password by querying the memory 112 to determine the predefined rhythm-based password that is most similar to the rhythm-based password entered by the user. To determine the similarity of the rhythm-based password entered by the user to the predefined rhythm-based passwords, the processor 110 may determine the similarity of one or more properties of the rhythm-based password to respective properties of one or more predefined rhythm-based passwords. The similarity of the respective properties may be determined in various manners, such as by determining the Euclidian distance between the respective properties or by determining the distance between the respective properties based upon Dynamic Time Warping. Based upon the similarity of the respective properties, the processor 110 may determine the predefined rhythm-based password that is most similar to the rhythm-based password entered by the user. In one embodiment, the processor 110 may then determine the strength value of the rhythm-based password entered by the user based upon the strength value of the predefined rhythm-based password that is most similar. For example, the processor 110 may determine the strength value of the rhythm-based password entered by the user to be equal to the strength value of the predefined rhythm-based password that is most similar.

Additionally or alternatively, the processor 110 may be configured to determine if the rhythm-based password entered by a user is commonplace, thereby indicating that the rhythm-based password may be relatively weak. In this regard, the processor 110 may be configured to query a network-based element, such as a password server, or local storage, such as memory 112, as to the frequency with which the rhythm-based password is utilized by other users. The network-based element or local storage may maintain a listing of the rhythm-based passwords utilized by various users as well as the frequency with which the rhythm-based passwords are utilized. By comparing the frequency to a predefined threshold, the network-based element may advise the processor 110 or the processor may determine by reference to the local storage that the rhythm-based password is commonplace and, therefore, relatively low in strength. In this regard, a rhythm-based password may be considered commonplace in an instance in which the frequency exceeds the predefined threshold. Alternatively, the processor 110 may determine that the rhythm-based password is uncommon and, therefore, relatively high in strength, in an instance in which the frequency with which the rhythm-based password is utilized is below the predefined threshold, The network-based element may track the usage of rhythm-based passwords on an ongoing basis or the local storage may receive updated information regarding usage of the rhythm-based passwords such that the processor 110 may be alerted by the network-based element or by reference to the local storage following the user's selection of the rhythm-based password if the rhythm-based password is determined to become commonplace, such that the user can change the rhythm-based password if so desired.

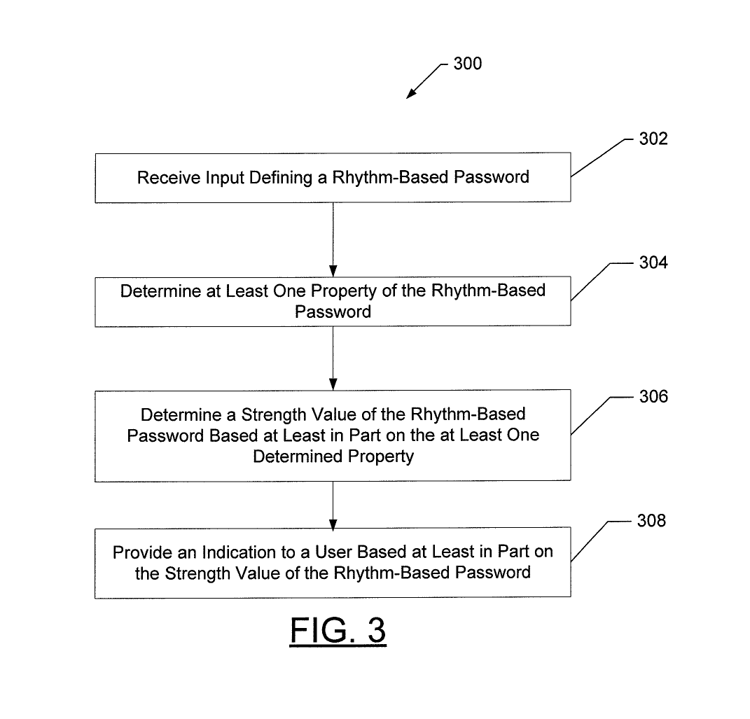

Various examples of the operations performed in accordance with embodiments of the present invention will now be provided with reference to FIGS. 3-7. In this regard, FIG. 3 illustrates a flowchart of the operations for determining strength of a rhythm-based password according to an example embodiment 300. Initially, user input defining a rhythm-based password may be received at operation 302. The processor 110, user interface 116, sensor 118, and/or UI control circuitry 122 may, for example, provide means for performing operation 302. At least one property of the rhythm-based password entered by the user may then be determined at operation 304. As described above, the determination of at least one property of the rhythm-based password may include the determination of at least one property of the rhythm-based password on an overall basis such as a length of the rhythm-based password, a variation within the rhythm-based password or a time for entry of the rhythm-based password. Additionally or alternatively, the determination of at least one property of the rhythm-based password may include the determination of at least one rhythmic property, such as a size of the intervals, a similarity between consecutive intervals or a presence of one or more predefined impulse sequences. The determination of at least one property of the rhythm-based password may also or alternatively include the determination of at least one of an attack velocity, decay, sustain time or release velocity of the impulses of the rhythm-based password. The processor 110 may, for example, provide means for performing operation 304.

The strength value of the rhythm-based password may then be determined based at least in part on the at least one determined property as shown in operation 306. As noted above, the strength value of a rhythm-based password may be determined based upon the scores of the various properties of the rhythm-based password, such as by combining, e.g., summing, the scores of the various properties of the rhythm-based password, either with or without weighting of the scores. The processor 110 may, for example, provide means for performing operation 306. As shown in operation 308, an indication may also be provided to a user based upon the strength value of the rhythm-based password. While various indications of the strength may be provided, the indication may be the strength value and/or a percentage corresponding to the relationship of the strength value to a maximum strength value. The processor 110, user interface 116 and/or UI control circuitry 122 may, for example, provide means for performing operation 308.

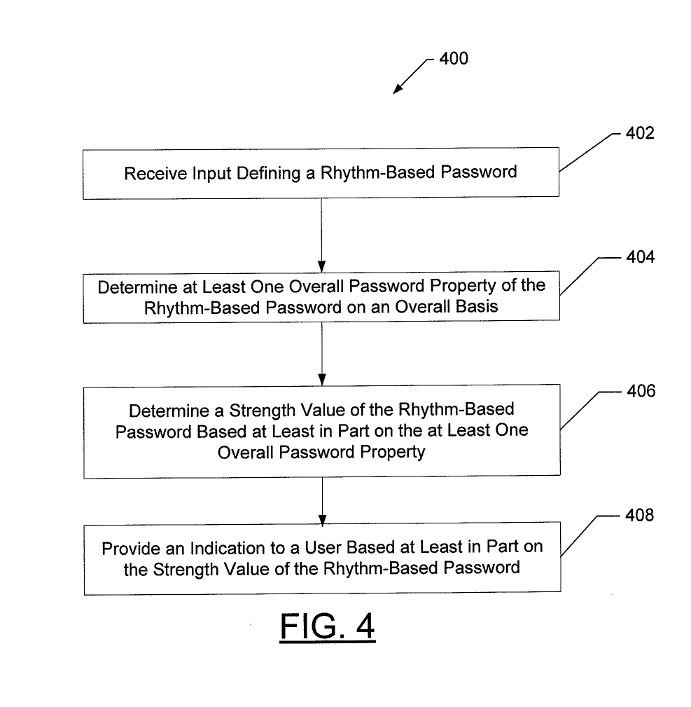

FIG. 4 illustrates a flowchart of the operations for determining strength of a rhythm-based password according to another embodiment. Initially, user input defining a rhythm-based password may be received at operation 402. The processor 110, user interface 116, sensor 118, and/or UI control circuitry 122 may, for example, provide means for performing operation 402. At least one overall password property of the rhythm-based password may then be determined on an overall basis at operation 404. As described above, the determination of at least one overall password property of the rhythm-based password may include determination of a length of the rhythm-based password, a variation within the rhythm-based password or a time for entry of the rhythm-based password. The processor 110 may, for example, provide means for performing operation 404. The strength value of the rhythm-based password may then be determined based at least in part on the at least one property that has been determined on an overall basis as shown in operation 406 and as described above in conjunction with operation 306. The processor 110 may, for example, provide means for performing operation 406. As shown in operation 408, an indication may also be provided to a user based upon the strength value of the rhythm-based password. The processor 110, user interface 116 and/or UI control circuitry 122 may, for example, provide means for performing operation 408.

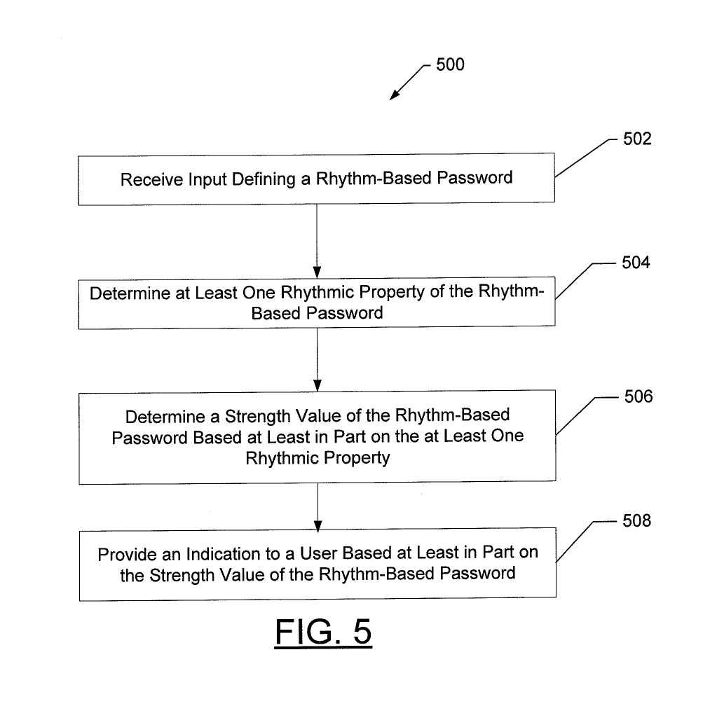

FIG. 5 illustrates a flowchart of the operations for determining strength of a rhythm-based password according to another embodiment. Initially, user input defining a rhythm-based password may be received at operation 502. The processor 110, user interface 116, sensor 118, and/or UI control circuitry 122 may, for example, provide means for performing operation 502. At least one rhythmic property of the rhythm-based password may then be determined at operation 504. As described above, the determination of at least one rhythmic property of the rhythm-based password may include determination of a size of the intervals, a similarity between consecutive intervals or a presence of one or more predefined impulse sequences. The processor 110 may, for example, provide means for performing operation 504. The strength value of the rhythm-based password may then be determined based at least in part on the at least one rhythmic property that has been determined as shown in operation 506 and as described above in conjunction with operation 306. The processor 110 may, for example, provide means for performing operation 506. As shown in operation 508, an indication may also be provided to a user based upon the strength value of the rhythm-based password. The processor 110, user interface 116 and/or UI control circuitry 122 may, for example, provide means for performing operation 508.

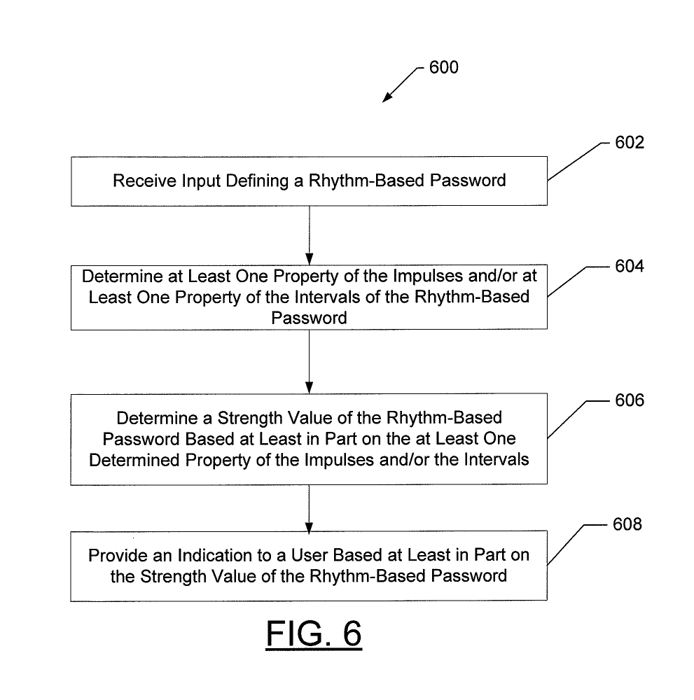

FIG. 6 illustrates a flowchart of the operations for determining strength of a rhythm-based password according to yet another embodiment. Initially, user input defining a rhythm-based password may be received at operation 602. The processor 110, user interface 116, sensor 118, and/or UI control circuitry 122 may, for example, provide means for performing operation 602. At least one property of the impulses and/or at least one property of the intervals of the rhythm-based password may then be determined at operation 604. As described above, the determination of at least one property of the impulses and/or at least one property of the intervals of the rhythm-based password may include determination of an attack velocity, decay, sustain time or release velocity of the impulses of the rhythm-based password. The processor 110 may, for example, provide means for performing operation 604. The strength value of the rhythm-based password may then be determined based at least in part on the at least one property that has been determined as shown in operation 606 and as described above in conjunction with operation 306. The processor 110 may, for example, provide means for performing operation 606. As shown in operation 608, an indication may also be provided to a user based upon the strength value of the rhythm-based password. The processor 110, user interface 116 and/or UI control circuitry 122 may, for example, provide means for performing operation 608.

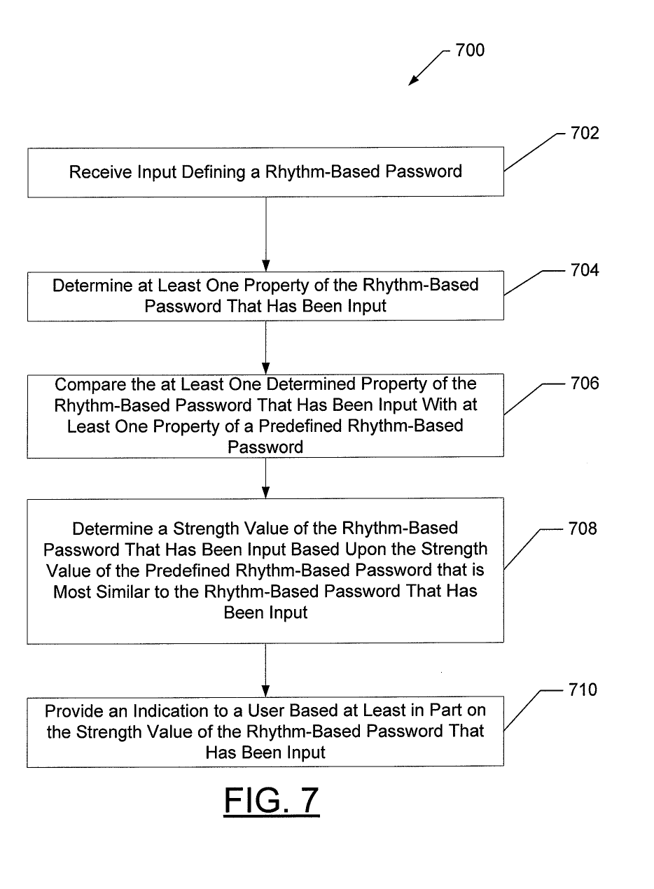

FIG. 7 illustrates a flowchart of the operations for determining strength of a rhythm-based password according to an example embodiment 700. A rhythm-based password may initially be received based upon user input at operation 702. The processor 110, user interface 116, sensor 118, and/or UI control circuitry 122 may, for example, provide means for performing operation 702. In operation 704, at least one property of the rhythm-based password may then be determined, such as described above in conjunction with operation 704. The processor 110 may, for example, provide means for performing operation 704.

As shown in operation 706 and as described above, at least one determined property of the rhythm-based password entered by the user may then be compared with respective properties of one or more predefined rhythm-based passwords, such as one or more predefined rhythm-based passwords stored in memory 112. For example, the respective properties of the rhythm-based password entered by the user and the predefined rhythm-based passwords may be compared by determining the mathematical distance between the respective properties. The processor 110 may, for example, provide means for performing operation 706. The strength value of the rhythm-based password entered by the user may then be determined, as shown in operation 708, based upon the strength value of a predefined rhythm-based password that is most similar to the rhythm-based password entered by the user. In this regard, the predefined rhythm-based password that is most similar may be determined based upon the mathematical distance between the respective properties of the rhythm-based password entered by the user and the one or more predefined rhythm-based passwords. The processor 110 may, for example, provide means for performing operation 708. As shown in operation 710, an indication may then be provided to a user based at least in part on the strength value of the rhythm-based password, such as described above in conjunction with operation 308. The processor 110, user interface 116, sensor 118, and/or UI control circuitry 122 may, for example, provide means for performing operation 710.

FIGS. 3-7 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
receiving input defining a rhythm-based password;
determining, by a processor, at least one property of the rhythm-based password; and
determining a strength value of the rhythm-based password based at least in part on the at least one property of the rhythm-based password.

2. The method of claim 1 wherein determining at least one property comprises determining at least one property of the rhythm-based password on an overall basis, and wherein determining a strength value comprises determining the strength value based on the at least one property of the rhythm-based password on an overall basis.

3. The method of claim 2 wherein determining at least one property of the rhythm-based password on an overall basis comprises determining at least one of a length of the rhythm-based password, a variation within the rhythm-based password or a time for entry of the rhythm-based password.

4. The method of claim 1 wherein determining a strength value comprises comparing the at least one property of the rhythm-based password to respective properties of one or more predefined rhythm-based passwords.

5. The method of claim 4 wherein comparing the at least one property of the rhythm-based password to respective properties of one or more predefined rhythm-based passwords comprises determining a distance between the at least one property of the rhythm-based password and the respective properties of the one or more predefined rhythm-based passwords, and wherein determining a strength value further comprises determining the strength value based upon a strength value of a predefined rhythm-based password that is most similar to the rhythm-based password based upon the distance between the at least one property of the rhythm-based password and respective properties of the one or more predefined rhythm-based passwords.

6. The method of claim 1 wherein determining at least one property comprises determining at least one rhythmic property based upon intervals between impulses that comprise the rhythm-based password.

7. The method of claim 6 wherein determining at least one rhythmic property comprises determining at least one of a size of the intervals, a similarity between consecutive intervals or a presence of one or more predefined impulse sequences.

8. The method of claim 1 wherein the rhythm-based password is comprised of a plurality of impulses spaced apart by intervals, and wherein determining the at least one property of the rhythm-based password comprises determining at least one property of the impulses or at least one property of the intervals.

9. The method of claim 8 where determining at least one property of the impulses comprises determining at least one of an attack velocity, decay, sustain time or release velocity of the impulses of the rhythm-based password.

10. An apparatus comprising at least one processor and at least one memory storing computer program code, wherein the at least one memory and stored computer program code are configured, with the at least one processor, to cause the apparatus to at least:
receive input defining a rhythm-based password;
determine at least one property of the rhythm-based password; and
determine a strength value of the rhythm-based password based at least in part on the at least one property of the rhythm-based password.

11. The apparatus of claim 10 wherein the at least one memory and stored computer program code are configured, with the at least one processor, to cause the apparatus to:
determine at least one property by determining at least one property of the rhythm-based password on an overall basis; and
determine a strength value by determining the strength value based on the at least one property of the rhythm-based password on an overall basis.

12. The apparatus of claim 11 wherein the at least one memory and stored computer program code are configured, with the at least one processor, to cause the apparatus to determine at least one property of the rhythm-based password on an overall basis by determining at least one of a length of the rhythm-based password, a variation within the rhythm-based password or a time for entry of the rhythm-based password.

13. The apparatus of claim 10 wherein the at least one memory and stored computer program code are configured, with the at least one processor, to cause the apparatus to determine a strength value by comparing the at least one property of the rhythm-based password to respective properties of one or more predefined rhythm-based passwords.

14. The apparatus of claim 13 wherein the at least one memory and stored computer program code are configured, with the at least one processor, to cause the apparatus to:
compare the at least one property of the rhythm-based password to respective properties of one or more predefined rhythm-based passwords by determining a distance between the at least one property of the rhythm-based password and the respective properties of the one or more predefined rhythm-based passwords; and
determine a strength value further by determining the strength value based upon a strength value of a predefined rhythm-based password that is most similar to the rhythm-based password based upon the distance between the at least one property of the rhythm-based password and respective properties of the one or more predefined rhythm-based passwords.

15. The apparatus of claim 10 wherein the at least one memory and stored computer program code are configured, with the at least one processor, to cause the apparatus to determine at least one property by determining at least one rhythmic property based upon intervals between impulses that comprise the rhythm-based password.

16. The apparatus of claim 15 wherein the at least one memory and stored computer program code are configured, with the at least one processor, to cause the apparatus to determine at least one rhythmic property by determining at least one of a size of the intervals, a similarity between consecutive intervals or a presence of one or more predefined impulse sequences.

17. A computer program product comprising at least one non-transitory computer-readable storage medium having computer-readable program instructions stored therein, the computer-readable program instructions comprising program instructions configured to cause an apparatus to perform a method comprising:
receiving input defining a rhythm-based password;
determining at least one property of the rhythm-based password; and
determining a strength value of the rhythm-based password based at least in part on the at least one property of the rhythm-based password.

18. The computer program product of claim 17 wherein determining at least one property comprises determining at least one property of the rhythm-based password on an overall basis, and wherein determining a strength value comprises determining the strength value based on the at least one property of the rhythm-based password on an overall basis.

19. The computer program product of claim 17 wherein determining a strength value comprises comparing the at least one property of the rhythm-based password to respective properties of one or more predefined rhythm-based passwords.

20. The computer program product of claim 17 wherein determining at least one property comprises determining at least one rhythmic property based upon intervals between the impulses that comprise the rhythm-based password.
